(19) United States
(12) Patent Application Publication
(10) Pub. No.: US 2026/0046234 A1
(43) Pub. Date: Feb. 12, 2026

(54) EVENT DETECTION AND PROBLEM DOMAIN IDENTIFICATION USING USER-CONFIGURED NETWORK MEASUREMENTS

(71) Applicant: Cisco Technology, Inc., San Jose, CA (US)

(72) Inventors: Abbas Razaghpanah, San Francisco, CA (US); Seyed Arian Akhavan Niaki, South San Francisco, CA (US); Arash Molavi Kakhki, San Francisco, CA (US); Sambarta Dasgupta, Milpitas, CA (US); Udit Paul, Harrison, NY (US)

(73) Assignee: Cisco Technology, Inc., San Jose, CA (US)

(21) Appl. No.: 19/266,402

(22) Filed: Jul. 11, 2025

Related U.S. Application Data
(60) Provisional application No. 63/680,448, filed on Aug. 7, 2024.

(51) Int. Cl. H04L 43/50; H04L 41/0631; H04L 43/045

(52) U.S. Cl. CPC H04L 43/50; H04L 41/0631; H04L 43/045

(57) ABSTRACT

In one implementation, a device obtains test results from a plurality of performance monitoring tests performed in a computer network. The device identifies a set of components of the computer network as potential causes of the test results. The device determines that a particular component from among the set of components caused the test results based on its health metrics. The device raises an alert indicative of the particular component having caused the test results.

### RELATED APPLICATION

The application claims priority to U.S. Prov. Appl. Ser. No. 63/680,448, filed Aug. 7, 2024, entitled EVENT DETECTION AND PROBLEM DOMAIN IDENTIFICATION USING USER-CONFIGURED NETWORK MEASUREMENTS, by Abbas Razaghpanah, et al., the contents of which are incorporated herein by reference.

### TECHNICAL FIELD

The present disclosure relates generally to computer networks and more particularly to event detection and problem domain identification using user-configured network measurements.

### BACKGROUND

Large-scale networks support a wide range of operations, requiring constant monitoring and analysis to ensure optimal performance. However, with the increasing complexity and scale of these networks, identifying and resolving issues in a timely manner has become a significant challenge.

Currently, network monitoring relies heavily on manual analysis of test results to pinpoint the root causes of failures. This process involves configuring tests, setting intervals, and interpreting a wide range of outcomes. Additionally, it requires a deep understanding of the network infrastructure and an ability to discern meaningful data from noise. This manual approach is both time-consuming and resource-intensive, often requiring specialized expertise to manage effectively.

Further, in today's manual network monitoring approaches, user-configured tests may provide arbitrary or suboptimal coverage, leading to missed or misdiagnosed issues. Testing intervals that fail to yield a usable baseline further complicate the detection of anomalies. Additionally, the vast array of potential root causes for test failures and the presence of noise, such as frequent test failures of diurnal patterns in failure rates, exacerbate the difficulty of accurate analysis. These challenges result in delayed response times and increased operational costs, making the current approach untenable for many users. Without an efficient and automated solution, maintaining network reliability and performance poses significant risks.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of a categorized test database for event detection and problem domain identification using user-configured network measurements;

FIG. 5 illustrates an example of an architecture for event detection and problem domain identification using user-configured network measurements;

FIG. 6 illustrates an example of a graph of a component health baseline for a proxy component;

FIG. 7 illustrates an example of a plot of a multi-modal time series-latency;

FIG. 8 illustrates an example of a graph illustrating the computation of probabilities for anomaly detection;

FIG. 9 illustrates an example of a pseudocode representation of the empirical distribution-based anomaly detector operations;

FIG. 10 illustrates an example of an architecture for a grouping process for event detection and problem domain identification using user-configured network measurements;

FIG. 11 illustrates an example of an event detection flow chart 800 for event detection and problem domain identification using user-configured network measurements;

FIG. 12 illustrates an example of a call diagram for CEA event detector utility for event detection and problem domain identification using user-configured network measurements;

FIG. 13 illustrates an example of a query for fetching ping baseline data for event detection and problem domain identification using user-configured network measurements;

FIG. 14 illustrates an example of a measurement class for event detection and problem domain identification using user-configured network measurements;

FIG. 15 illustrates an example of a MeasurementSuite class for event detection and problem domain identification using user-configured network measurements;

FIG. 16 illustrates an example of a MeasurementSuite object that is stored as a pickle file for event detection and problem domain identification using user-configured network measurements;

FIG. 17 illustrates an example of a test data hierarchy for event detection and problem domain identification using user-configured network measurements;

FIG. 18 illustrates and example of an agent class for event detection and problem domain identification using user-configured network measurements;

FIG. 19 illustrates an example of an AgentTest class for event detection and problem domain identification using user-configured network measurements;

FIG. 20 illustrates an example of an error classification tree for ping data in event detection and problem domain identification using user-configured network measurements;

FIGS. 21A-21B illustrate an example of an error classification tree for HTTP data in event detection and problem domain identification using user-configured network measurements;

FIG. 22 illustrates an example of event decision data for event detection and problem domain identification using user-configured network measurements;

FIG. 23 illustrates an example of an interface of a utility for event detection and problem domain identification using user-configured network measurements; and

FIG. 24 illustrates an example simplified procedure for event detection and problem domain identification using user-configured network measurements, in accordance with various implementations herein.

### DESCRIPTION OF EXAMPLE IMPLEMENTATIONS

### Overview

According to one or more implementations of the disclosure, a device obtains test results from a plurality of performance monitoring tests performed in a computer network. The device identifies a set of components of the computer network as potential causes of the test results. The device determines that a particular component from among the set of components caused the test results based on its health metrics. The device raises an alert indicative of the particular component having caused the test results.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

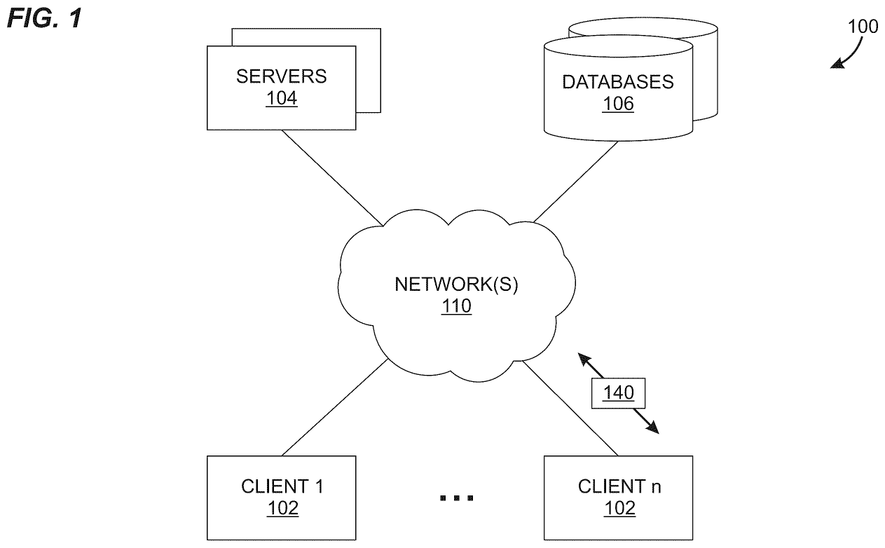

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

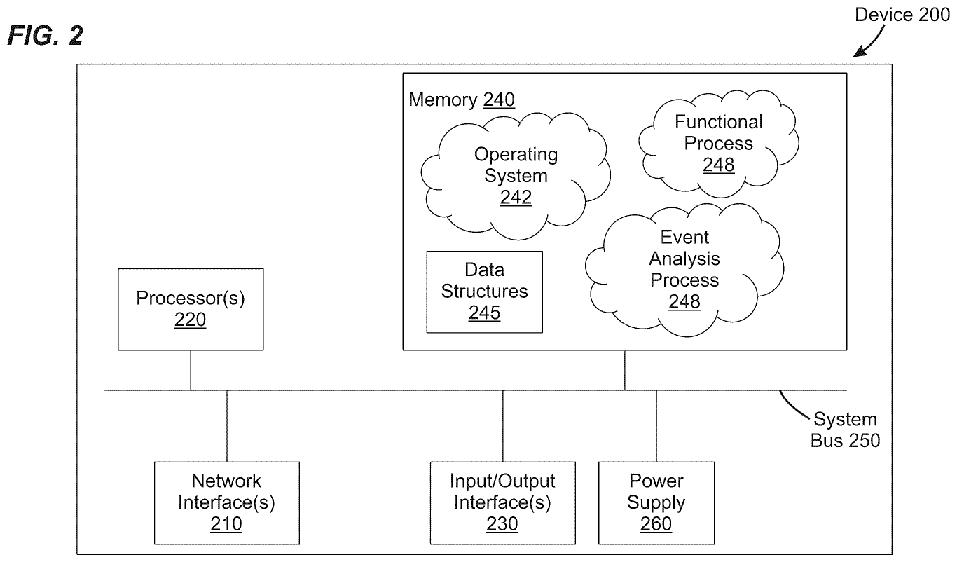

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative process such as event analysis process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, event analysis process 248 may include computer executable instructions that, when executed by processor 220, cause device 200 to perform the techniques described herein. To do so, in some implementations, event analysis process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, event analysis process 248 may employ and/or be utilized to handle prompts to and/or access of one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the event analysis process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, event analysis process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring an observability platform to perform certain application analytics, event analysis process 248 may be a component of, use, and/or be utilized in the management of prompts/access to a generative model to perform error classification, baselining, noise suppression, component tagging, network mapping, generate configurations, perform analyses, perform root cause analysis, or other outputs based on a conversational input from a user (e.g., voice, text, etc.). In another example, event analysis process 248 may utilize a generative model with a method invocation data collector (MIDC) to assist in automated or manual identification of transactional attributes for spans. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

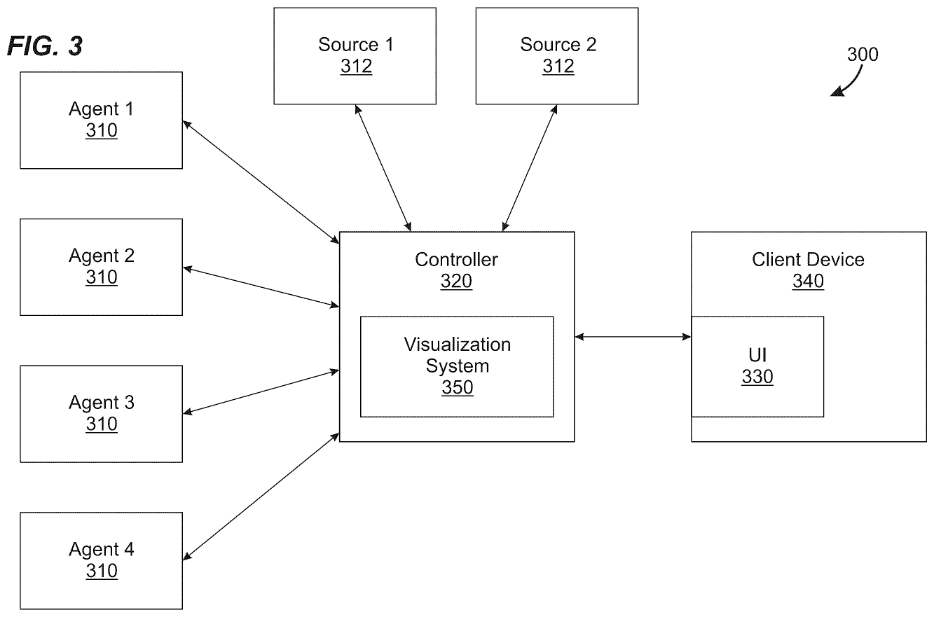

FIG. 3 is a block diagram of an example of an observability intelligence platform 300 that can implement one or more aspects of the techniques herein. The observability intelligence platform 300 is a system that monitors and collects metrics of performance data for a network and/or application environment being monitored. At the simplest structure, the observability intelligence platform 300 includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform 300. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

As noted above, observability platforms facilitate automated testing and measurement data collection of network infrastructure. However, manually analyzing test results to find the root cause when problems arise, especially in large corporate networks with many accounts across different regions with hundreds or thousands of tests, can be a daunting task.

Therefore, a mechanism for automatically detecting events (e.g., HTTP tests failing) and correctly identifying the problem domain (e.g., test target problem) in a timely manner would help users allocate their resources appropriately to address issues that lead to events, which not only saves them a great deal of time, but also eliminates the need for the expertise and resources that would be required to perform similar analyses manually. Additionally, having these capabilities built into observability platforms may eliminate the need for our customers to take measurement data collected by observability platforms (such as ThousandEyes) to competing utilities to outsource event detection and root-cause analysis, further bolstering the position of an observability platforms not just as a data collection tool, but as an end-to-end solution to monitoring and detecting anomalies across the network.

Cloud and enterprise agents generate a large amount of active measurement data covering the network layer to the application layer. To detect anomalies across their corporate network, users have previously relied on alerts. However, automatically detecting the occurrence and finding the root cause of events in the network using user-configured measurements can be a difficult problem to solve. For example, tests being configured by users may result in arbitrary or suboptimal coverage of key components and infrastructure. That is, user configuration dependent alerting generally relies on the user knowing how to configure alerts correctly to meet their needs. Alert misconfiguration can lead to alert fatigue where poor alert configuration result in too many alerts, overwhelming and/or desensitizing users charged with monitoring alerts.

In addition, there are frequent alert duplications in automated detection whereby problems in lower layers create duplicate alerts higher up the stack (e.g., network layer problems trigger not just network layer alerts, but also application layer ones). Further, arbitrary testing intervals can fail to yield a usable baseline to compare against. Furthermore, this approach often suffers from having no clear indication of a root cause since alerts often don't indicate what's the root cause of the issue. There can also be a wide array of test outcomes, each with a range of possible root causes. Additionally, the presence of noise (e.g., tests failing too often, diurnal patterns in failure rates caused by high load, etc.) can obfuscate root cause identification. Generally, automated detection approaches lack important contextual knowledge about the infrastructure and network layout.

Moreover, automated alert detection is often limited to a single test and cannot detect problems affecting multiple tests (or tests from different accounts within the same organization), or problems that are not specific to any one test type (e.g., DNS issues affecting every test type). This approach requires expert knowledge, requiring deeper understanding of test layers such as HTTP availability and response time, end-to-end loss and latency, forwarding loss, BGP path changes, and perhaps more, to manually diagnose root cause. This inhibits broader growth across less-advanced network users.

As such, there are currently no solutions that can detect events in the network and find the root cause in near-real-time using user-defined tests without requiring specific testing configurations and extensive knowledge about the components and infrastructure involved.

### Event Detection and Problem Domain Identification Using User-Configured Network Measurements

In contrast, the techniques described herein introduce just such a system that can detect network events, agent events, target events, application events, etc. and find the root cause in near-real-time using user-defined tests. These techniques may accomplish this functionality by taking a multi-step approach to processing, filtering, baselining, and grouping of test outcomes (i.e., “signals”).

These techniques may remove dependency on user-configured alerts to detect problems. In addition, these techniques provide cross-layer, cross-test, and cross-account root-cause analysis that can be leveraged to detect problems that span over multiple test layers, and across multiple tests from accounts across entire organizations. Further, these techniques may increase the signal-to-noise ratio (SNR) of problem detection, leveraging a current baseline including a number of users that interact with an alert and/or a number of total alerts generated, as well as future metrics including a number of users that subscribe/interact with an event and/or a number of total events generated. The future metrics may be markedly higher than the current baseline. Furthermore, these techniques may build a feedback loop from users that improves event detection over time based on user needs. This may be captured through explicit user feedback form that could display after event interaction.

Illustratively, the techniques described herein may be performed by hardware, software, and/or firmware, such as in accordance with event analysis process 248, which may include computer executable instructions executed by the processor 220 (or independent processor of interfaces 210) to perform functions relating to the techniques described herein.

Specifically, according to various implementations, a device obtains test results from a plurality of performance monitoring tests performed in a computer network. The device identifies a set of components of the computer network as potential causes of the test results. The device determines that a particular component from among the set of components caused the test results based on its health metrics. The device raises an alert indicative of the particular component having caused the test results.

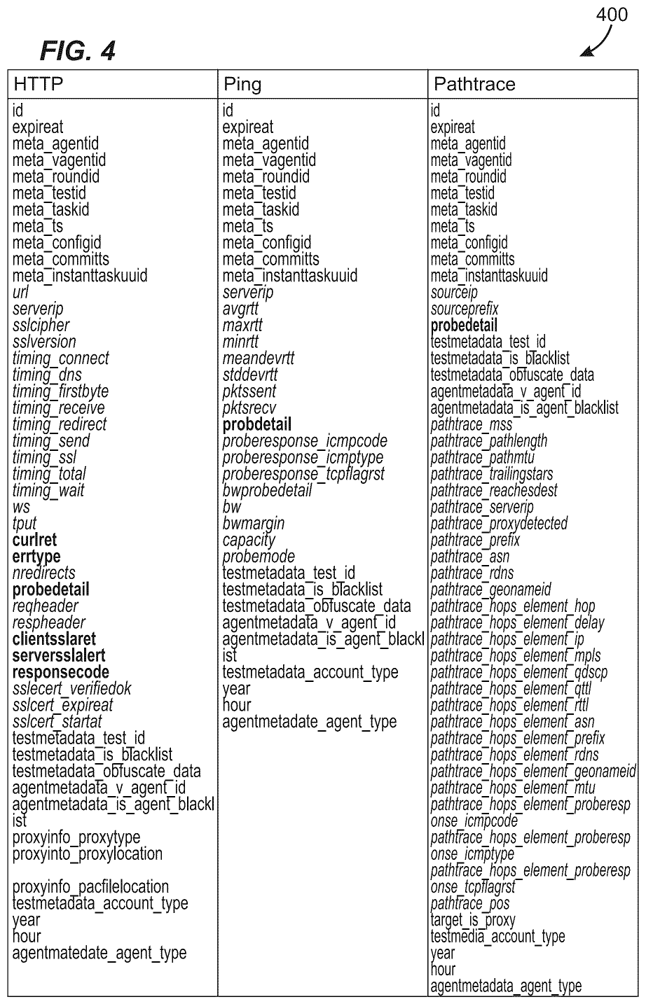

Operationally, FIG. 4 illustrates an example of a categorized test database 400 for event detection and problem domain identification using user-configured network measurements, in accordance with one or more implementations described herein. Specifically, categorized test database 400 may include a collection of information stored in a database for each test type, graphically coded by data category. The categorized test database 400 may be a component of and/or utilized in cloud and enterprise agent (CEA) detection utility.

A single measurement suite, identified by its unique vAgentId, testId, and/or taskId combination, may be any combination of a page load test, HTTP test, network test, and path trace test from the same vAgent, to the same test target, and with the same test configuration and interval. Note that for a measurement suite to be valid, only one of these components may be required.

There may be different entities involved in each test. For context about how they relate to each other, an example observability platform may have a set of users that can be identified as organizations (e.g., each identified by its unique orgId). Each organization can have many accounts, each identified with a unique aid. Each account can create a set of tests (e.g., each identified by a unique testId). Each test may be run by a set of virtual agents, each of which can either be a customer-owned “enterprise” virtual agent or an observability platform-owned “cloud” virtual agent. Each virtual agent (vAgent, for short) may be denoted by its unique vAgentId. The vAgents themselves can spawn multiple agents inside virtual machines, each denoted by a unique agentId, to run the tests. The information stored for each test on the database is listed in categorized test database 400.

With respect to HTTP testing, a HTTP test sends a request to an HTTP server to measure its response. These tests may be configured by clients who can configure the test to match their desired outcome (e.g., a test might be configured to always expect an HTTP 404). These tests may be carried out by the vAgents using cURL, and the results include HTTP request and response headers and status codes, relevant TLS handshake data, timing information, and the cURL return code, among other data.

With respect to ping testing, a network test or a ping test may be a type of network availability test where the vAgent sends 50 probe packets to the target and measures its response. A maximum of fifty TCP SYN-SACK-based probes may be sent by default, although in some scenarios the agent might fall back on TCP SYN or ICMP probes based on target support and test configuration. The result may contain the number of probes sent and the number of responses received, as well as some timing statistics (e.g., minimum/average/maximum round-trip times, etc.) and other relevant information.

With respect to path trace testing, a path trace test may be performed to study the network hops between the vAgent and the test target, similar to a regular traceroute test. If at any hop along the path there is one hundred percent forwarding packet loss, then we deem this test to be “terminal”. This may assist in identifying if there's a clear failure along the route.

Tests can have a range of outcomes such as: a test could finish successfully with a desirable outcome; it could fail to finish within a pre-configured time limit (e.g., a timeout event); it could finish in time but take significantly longer than usual; it could yield an unexpected or undesirable result (e.g., expected an HTTP 404 response code, but received an HTTP “200” response code instead); it could end in some other type of error (e.g., the ping test failed to send any packets, etc.). All of these outcomes may need to be accounted for, processed, classified, and labeled correctly so that they can be used for event analysis later.

A component may be any entity involved in a test which can be identified and for which stats can be accurately gathered. Some main component types may include agent, test target, proxy, network path (e.g., specified by the source and destination autonomous systems (ASes) and locations), etc.

A signal may be a test outcome in a single round that can be processed and classified. For instance, a measurement suite that tests google.com may be a “signal” for the agent that ran the test, that test target (google.com), the proxy (if one was used), and the network path(s) that were taken when running the test (from the agent's network to the target's network).

Error signals may be defined as any measurable and significant deviation from the normal expected outcome for a given signal. For instance, an HTTP test that results in a 5xx HTTP status code compared to the usual “200”, may be considered an error signal. For a Ping test, an error signal might be a significant increase in average delay compared to the baseline, or packet loss percentage that goes above a certain threshold (e.g., a THRESHOLD_E2E_LOSS). Note that loss may be a normalized metric and may not need to be baselined.

An event may be a set of error signals that, when grouped together, identify a problem with a component and are thus likely to share a root cause. For instance, a large number of error signals towards one test target could be grouped together into a “Target” type event, provided that it clears the thresholds for that kind of event.

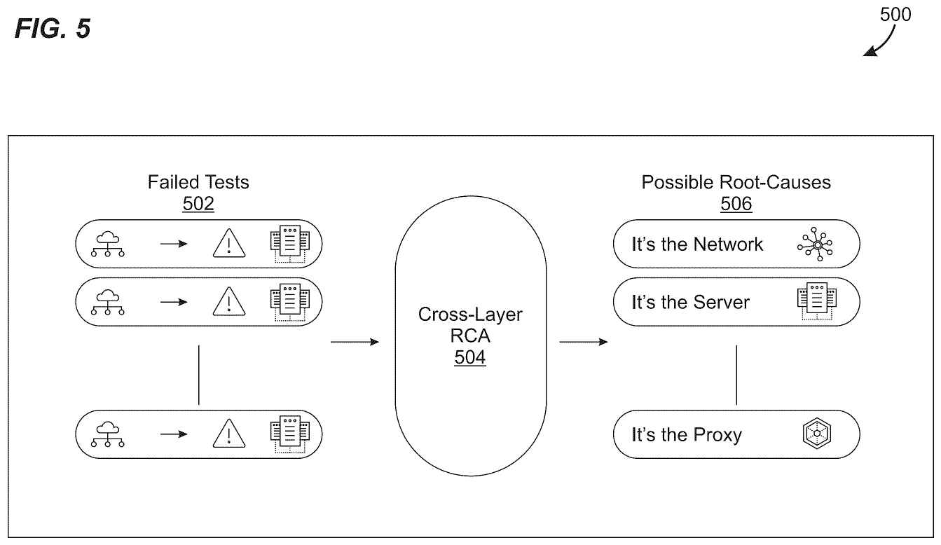

FIG. 5 illustrates an example of an architecture 500 for event detection and problem domain identification using user-configured network measurements, in accordance with one or more implementations described herein. Architecture 500 may be utilized in detecting events by taking a multi-step approach to processing, filtering, baselining, and grouping of test outcomes (i.e., signals). Architecture 500 may include an error classification process. First, the system may obtain the network performance test outcomes (also called “signals”), such as those for failed tests 502. In turn, the system may use one or more classifiers 504 configured to perform cross-layer root cause analysis (RCA), to identify the set of components of the network that are possible root causes 506. The gathering and/or classification of signals may be based on an internal classifier that maps signals to a predetermined scenario with a list of suspected components (e.g., [Agent, Proxy, Server]) that could be the root cause of the outcome (a.k.a. a suspect list).

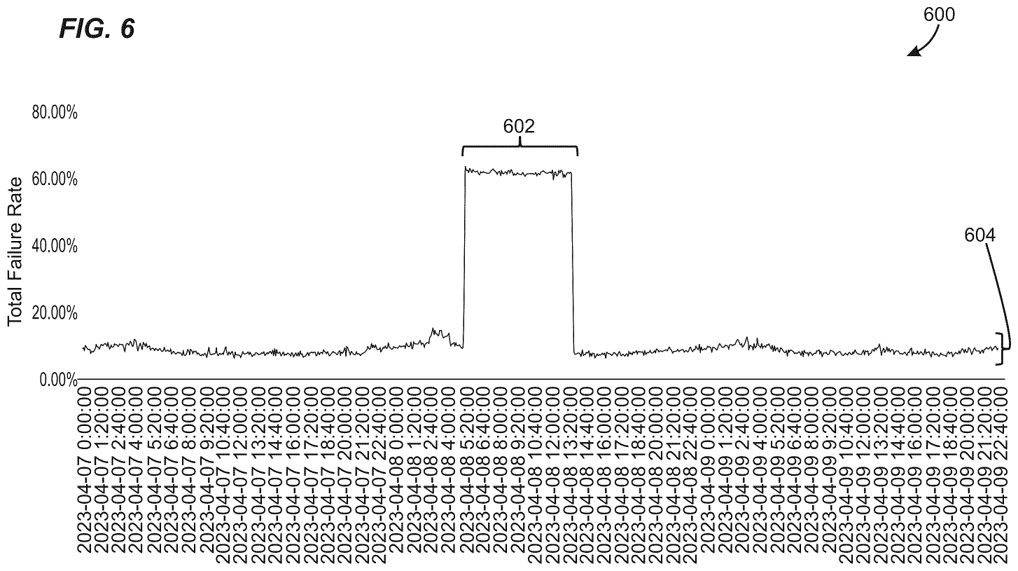

FIG. 6 illustrates an example of a graph 600 of a component health baseline for a proxy component, in accordance with one or more implementations described herein. Graph 600 may show a failure rate for a proxy component. In various implementations, the system may establish baselines for key performance metrics from the signals (e.g., average connect time and ping round-trip-time) and flag deviations from those baselines as anomalies. Additionally, a component's health may be baselined by tracking the percentage of failed signals touching that component per unit of time. That way, events for components may be called only when their signal failure rates exceed normal levels.

Graph 600 shows the failure rate baseline (e.g., baseline 604) for a proxy component. As a baseline 604, this proxy component always has a non-zero failure rate. The area in the middle (e.g., event 602) clearly denotes a deviation from that baseline 604, which could potentially point to an event 602 involving that proxy.

In various instances, using fixed thresholds for detecting anomalies may not make sense. For example, a round-trip time (RTT) of 100 ms for a test that has a consistent 10 ms RTT should be considered an issue, while another test might always have a 100 ms RTT. To avoid a one-size-fits-all trap, baselining may be utilized. For instance, a rolling window may be utilized to constantly update what the “normal” value is for a metric and trigger an anomaly if a statistically significant divergence from that norm is observed. Further, with respect to baselining timing, the system may baseline each network test's average delay, as well as each HTTP test's total time+redirect time.

Components of the computer network under scrutiny can have varying degrees of availability when they operate normally. That means that, absent an event 602, the component will have a baseline rate of signal failure at any given time. In order to avoid raising events based on fail signals that are really just “business as usual” for each component, a baseline 604 may be established and events may only be raised when the signal failure rate shoots above baseline levels.

In various implementations, noise suppression may be applied to filter out noisy signals. This filtering may be based on a penalizing process that is configured to suppress signals with too many failures over a short span of time.

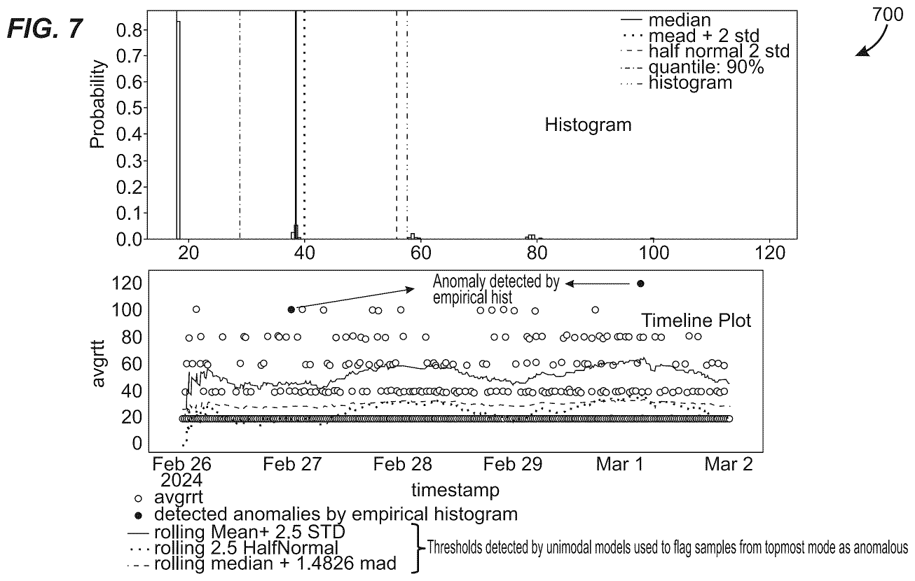

FIG. 7 illustrates an example of a plot 700 of a multi-modal time series-latency (e.g., average round-trip time (avgrtt) for a signal), which may be involved in baselining operations multi-modal timing metrics. The baselining operations in CEA event detection may involve detecting anomalous timing measurements as reported in the outcome of HTTP and ping tests such as connection time, wait time, SSL/TLS handshake time—for each unique combination of test and testing agent. For instance, the values for TCP connection time over a period of time for a unique test/agent combination may form a time series. Any sudden or large jump in the connection time would constitute an anomaly. The detected anomalies may be further grouped into different components which result in the detected events.

Baselining operations may be utilized to estimate the probability distribution from the data in an online manner and based on the estimated probability distribution, may predict if the present sample of the timing metric is an anomaly or not. As such, the baselining operations may operate as an empirical distribution-based anomaly detector.

In plot 700, the blue dots (in the second plot) represent the avgrtt for a specific test for a period of time. Here, there are the parallel braids of values, forming horizontal dotted lines. These discrete levels correspond to the different modes of the distribution when a histogram is plotted for the avgrtt for the same test (the first plot)—the modes are close to 20, 40, 60, 80 and 100 ms.

Due to the presence of these distinct modes, the mean+2 standard deviation threshold would have identified the entire modes close to 60, 80 and 100 ms as anomalies. This may be due to there being different components (e.g., modes) of the data and the mean/std computation treating them as a part of the same distribution.

In the timeline plot, the mean+std thresholds, computed on a rolling window of 24 hours are shown; as can be seen the avgrtt values >60 are all flagged as anomalies. These would lead to a significant number of False Positives.

To detect anomalies for such multi-modal time series, the empirical histogram anomaly detection may be leveraged—which ends up reducing the false positives (as can be seen in the timeline plot). This may represent a computationally cheap alternative to Gaussian Mixture Model type ML models—essentially it is only necessary to consider the multi-modality of the probability distribution to detect the anomalies and not treat all the samples as a part of one homogenous distribution.

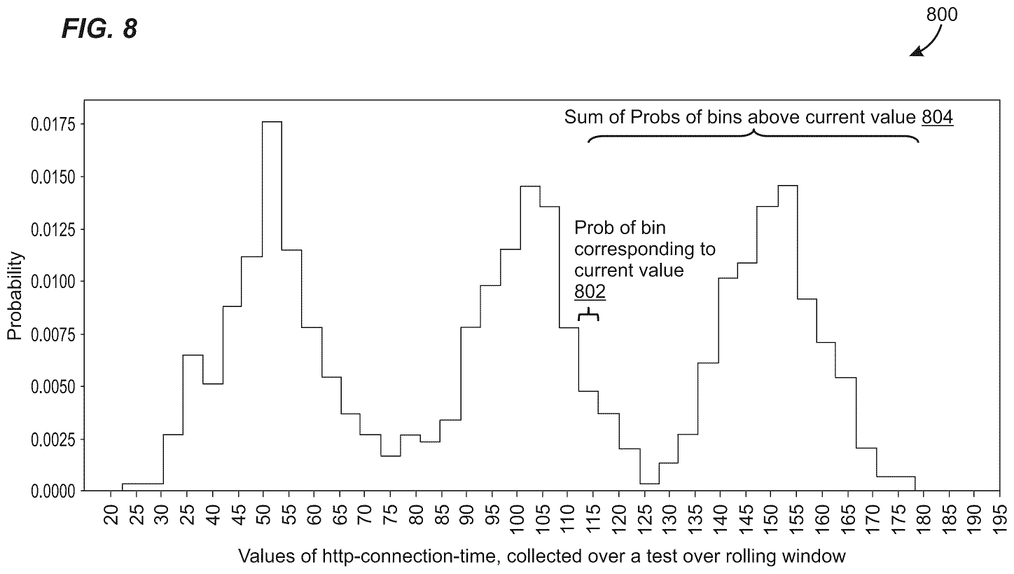

FIG. 8 illustrates an example of a graph 800 illustrating the computation of probabilities for anomaly detection. Since both clustering and Gaussian Mixture Models (GMM) may be computationally expensive for the event detection, an alternative approach may be utilizes based on the empirical probability distribution. Unlike GMM, which may operate by trying to fit model parameters, the alternative approach may operate by dividing the space of the values into bins. Furthermore, from the rolling window samples, an empirical probability distribution may be constructed with the hypothesis that with sufficient samples, it can model the actual data distribution (as per Glivenko-Cantelli Theorem).

The empirical distribution may be utilized to detect anomalies. The current value may be benchmarked against the probability distribution, estimated from the rolling window samples. The current value may be flagged as an anomaly, if the probability of the current value 802 is sufficiently small for the bin the current value falls in as well as the sum of probability of all the bins above 804 is sufficiently small.

For instance, consider an empirical probability distribution, constructed from the http connect time for a test and agent pair over a rolling window. The bin size may be five for such an example. Then, say the current value is 113.5 ms. The current value will be mapped to bin [110,115]. The value 113.5 ms may not be considered an anomaly as the probability of the bin, corresponding to the current value, as well as the sum of the probability of all the bins above the current value being relatively high.

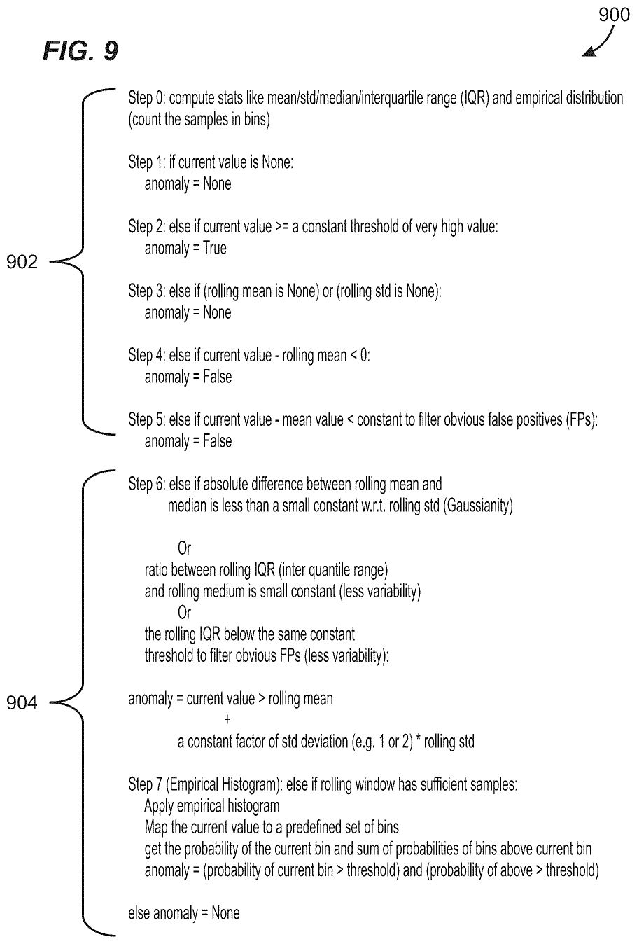

FIG. 9 illustrates an example of a pseudocode representation 900 of the empirical distribution-based anomaly detector operations. Here, some of the steps in the pseudocode are filtering and some involve statistical computation. The pseudocode representation 900 may include critical steps 904 and/or filtering stages 902.

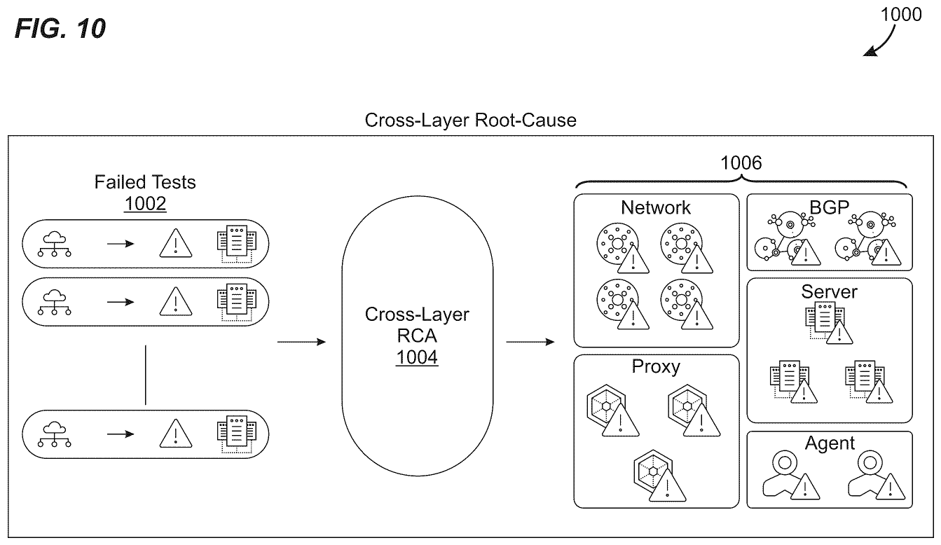

FIG. 10 illustrates an example of an architecture 1000 for a grouping process for event detection and problem domain identification using user-configured network measurements, in accordance with one or more implementations described herein. After the pre-processing and filtering steps, the system may group the signals, such as the test results for failed tests 1002, around the components that were involved (e.g., the agent that ran the test, the test target, etc.). For instance, every signal that tested Application X is grouped under that component (e.g., the Application X component).

Then, the current signal makeup for those components may be analyzed and/or compared to the health baseline of that component. If there is a significant deviation in the component's health (i.e., failure rate) and the error signals point to that component as a suspect, an event may be created for that component and lock those signals to the component and the event. The process may be iterated over the remaining signals, and the signals may be matched with their corresponding events when an event is detected until there are no more signals left, or until there are no more components that meet the event detection criteria.

In order to localize and group signals around the relevant affected components, all signals may first need to be processed to determine which ones were involved and which ones are likely to be the culprit (e.g., component tagging). For example, each layer of each measurement suite may be analyzed to determine the list of components that were involved in that test. That includes the agent, the target (or targets when the test redirects to a different target), the network path (or paths, depending on the redirected target's IP), and/or any proxies used.

If a test ends in error, a separate list of components suspected to be to blame for that outcome may be produced based on the results of an error classification. The error classification may be the result of an error classifier processing and labeling test outcomes based on the results and test metadata (e.g., test time limit, etc.). For example, a TCP connection timeout can be due to the agent having issues, the target (or the proxy when the test is proxied) having problems, and/or forwarding loss somewhere on the network path between the agent and the target; but an HTTP “500” outcome may be most likely to be caused by target-related problems.

All components may be pooled together from every layer (e.g., HTTP, Ping, Path, etc.) of every signal belonging to the same bucket (e.g., a grouping of data collected and/or aggregated for analysis over a fixed time interval such as 5 minutes). A state object may be created for each component (if one doesn't already exist) and added the relevant signals to that state object.

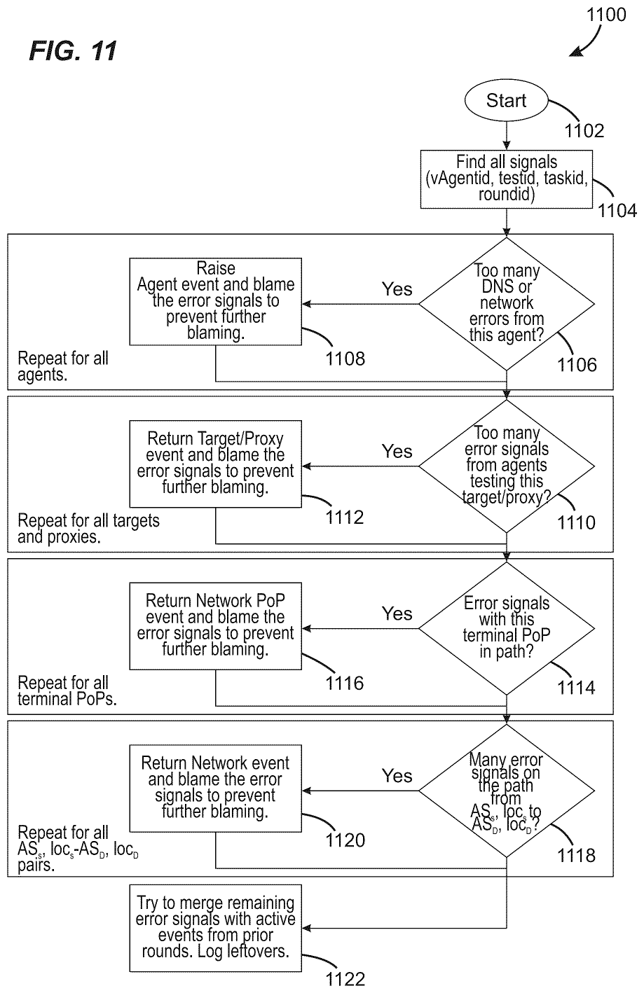

FIG. 11 illustrates an example of an event detection flow chart 1100 for event detection and problem domain identification using user-configured network measurements, in accordance with one or more implementations described herein. After the state objects are created for all of the components in each bucket and they are tagged with their relevant signals, analysis may begin into the makeup of those signals for each of the components in order to determine whether or not the signals have failed as a result of an event involving that component, or something else. More specifically, event detection flow chart 1100 may start at step 1102 and continue on to step 1104 where the system finds all signals (e.g., test results from agents, health information from components in the network, etc.).

A first criteria may be to determine whether a component's “health” has declined to below baseline levels for that time window. If the ratio of fail signals to all signals for a given component does spike above baseline levels for that bucket, the process may not proceed further in detecting an event for that component (an exception to this rule may be Network PoP events).

Starting with agents, the system may determine their ability to resolve domain names to IP addresses and their ability to successfully test targets in different networks. This may be done to decide whether the agent was capable of producing reliable measurement data for that round. If the error signals indicate that a significant portion of the agent's attempts at resolving domains to IP addresses have failed, or a large enough fraction of the networks where the agent's test targets are located are returning errors, that agent may be deemed faulty, and an agent event may be raised. For instance, at decision step 1106, the system may determine whether the test results from a given agent indicate too many DNS or network errors. If so, the system may proceed to step 1108 where it raises an agent event associated with those signals. The system may also prevent further signals from being blamed for the agent event, in some instances.

The process may proceed to proxies and test targets to determine whether they were generally available during that round or not. Analyzing and/or determining the number (and location diversity) of agents (and targets when considering proxy components) that have errors when testing the target (or testing through the proxy), it may be determined whether the fault affects other components (e.g., agents and targets) somewhat equally, indicating a problem with the target/proxy. For instance, at decision step 1110, the system may determine whether there are too many error signals from testing of the proxy. If so, at step 1112, the system may raise the target/proxy event associated with the signals. The system may also prevent further signals from being blamed for the event, in some instances.

Any remaining Network/PoP error signals may then be grouped into Network or Network (PoP) events, contingent upon thresholds being met. Event detection flow chart 1100 shows an example as to how this mechanism works for each bucket of test data. For instance, at decision step 1114, the system may determine whether there are too many error signals from testing of the PoP. If so, at step 1116, the system may raise the PoP event associated with the signals. The system may also prevent further signals from being blamed for the event, in some instances. Similarly, the system may repeat the above steps for any pairs of autonomous systems (AS) tested. For instance, at decision step 1118, the system may determine whether there are too many error signals from testing of the AS. If so, at step 1120, the system may raise the network event associated with the signals. The system may also prevent further signals from being blamed for the event, in some instances.

Various thresholds may be put in place and/or utilized to stop transient failures from being given too much weight when analyzing events. For instance, a target network event may only be raised if the same target is failed to be reached by at least two separate agents (e.g., from different ASN/location combinations) and more than twenty percent of the agents experience some kind of relevant failure towards that target. Examples of these thresholds and surfacing criteria are laid out below.

With respect to general event thresholds, one of the initial thresholds for all types of events may be having a minimum number of suspected/total signals. Having a minimum number of signals may help reduce noise and increase confidence about an event. Examples of these thresholds are included in Table 1 below.

With respect to threshold checking, there may be certain thresholds on different metrics. The thresholds may generally be defined using three values. Namely, MIN_THRESHOLD, PERCENTAGE_THRRESHOLD and MAX_THRESHOLD. For a variable to meet its threshold, its value may need to be at least more than MIN_THRESHOLD, and either be more than MAX_THRESHOLD or its percentage over all should be more than PERCENTAGE_THRRESHOLD. The MAX_THRESHOLD may allow coverage of cases where the PERCENTAGE_THRRESHOLD is not met, but where a significant number of failures is still detected.

For example, assume that the signals towards a target network component are being analyzed. As described below, a target network event may indicate network problems affecting a BGP prefix. However, a target network prefix could be unavailable due to a significant number of agents (e.g., thirty agents have problems testing the target) but still not meet its failure percentage threshold (e.g., fewer than 25% of all agents have errors testing the target in that bucket).

Agents that fail a high number of tests are usually considered to have local issues, causing an Agent event (e.g., with vAgentId as the event key). The criteria for surfacing these may be based on the percentage of root-level domain names whose subdomains the agent failed to resolve and/or the percentage of network paths (e.g., defined by source and destination AS and location) that have failed tests in them as tested by the agent. If either of these two conditions are met, an Agent event may be surfaced. 1. THRESHOLD_LOCAL_EVENT_FAILED_ROOT_DOMAIN_PERC and THRESHOLD_LOCAL_EVENT_FAILED_ROOT_DOMAIN_MIN may be the thresholds for the percentage and minimum number of total root domains with DNS issues, respectively. 2. THRESHOLD_LOCAL_EVENT_FAILED_ASN_PERC and THRESHOLD_LOCAL_EVENT_FAILED_ASN_MIN may be the thresholds for the percentage and minimum number of total target ASes that have failed tests from this agent, respectively. These thresholds may be stringent for cloud agents compared to enterprise agents, and may be labeled as follows: THRESHOLD_CA_LOCAL_EVENT_FAILED_ASN_PERC THRESHOLD_CA_LOCAL_EVENT_FAILED_ASN_MIN THRESHOLD_CA_LOCAL_EVENT_FAILED_ROOT_DOMAIN_PERC THRESHOLD_CA_LOCAL_EVENT_FAILED_ROOT_DOMAIN_MIN.

An application event may indicate issues with a target server (e.g., with its FQDN as event key) for a given bucket. The main failed signals associated with this event type may be application-layer errors (e.g., HTTP “500” server errors) and other server-related error types (e.g., TCP RST responses) that are more likely to be caused by an application or service problem rather than network issues. Since there may be more confidence associated with the mapping between application errors and the corresponding event type (e.g., there is far less ambiguity about what causes an HTTP “500” response to be sent compared to a generic timeout), the only thresholds may be to clear the universal event thresholds concerning the number of suspected/total signals.

A target network event may denote problems affecting test targets in the same network and general physical vicinity, as keyed by the BGP prefix. The overall count, percentage, and/or location diversity of agents that have problems reaching a target prefix may be utilized as the primary indicator of a Target Network event. The intuition behind that heuristic may be that if a network event is happening close to the target's network, then it will affect a diverse set of agents and paths leading to the affected network prefix, assuming that most BGP prefixes are routed the same way.

Thus, the following thresholds may be utilized. The agent count thresholds may include THRESHOLD_AVAILABILITY_MIN_AGENT_FAILURE, minimum number of agents with failed tests to this target, THRESHOLD_AVAILABILITY_MAX_AGENT_FAILURE, maximum number of agents with failed tests to this target (this threshold may be considered met regardless of percentage of agents with failed tests if the total number is greater than this threshold), and/or THRESHOLD_AVAILABILITY_PERC_AGENT_FAILURE, percentage of agents with failed tests to this target over all. The agent diversity thresholds may be based on the agent location and AS with failed tests to the following targets. The agent diversity thresholds may include THRESHOLD_AVAILABILITY_MIN_DIVERSE_AGENT_POP_FAILURE, minimum number of diverse agents, THRESHOLD_AVAILABILITY_MAX_DIVERSE_AGENT_POP_FAILURE, maximum number of diverse agents (e.g., this threshold may be considered met regardless of percentage of agents with failed tests if the total number is greater than this threshold), and/or THRESHOLD_AVAILABILITY_PERC_DIVERSE_AGENT_POP_FAILURE, percentage of diverse agents.

A proxy event may denote problems affecting agents that use the same proxy, as keyed by the proxy's FQDN. The overall count, percentage, and location diversity of agents that have problems going through this proxy, and the count and percentage of targets that reached using this proxy, and the connection attempts to the proxy may be utilized as the indicators of a proxy event. The intuition behind that heuristic may be that if a proxy event is happening, then it will affect a diverse set of agents connecting to this proxy and paths connected through this proxy.

Thus, the following thresholds may be utilized. The agent count thresholds may include THRESHOLD_AVAILABILITY_MIN_AGENT_FAILURE, minimum number of agents with failed tests to this proxy, THRESHOLD_AVAILABILITY_MAX_AGENT_FAILURE, maximum number of agents with failed tests to this proxy (this threshold may be considered met regardless of percentage of agents with failed tests if the total number is greater than this threshold), and/or THRESHOLD_AVAILABILITY_PERC_AGENT_FAILURE, percentage of agents with failed tests to this proxy over all.

The agent diversity thresholds may be based on the agent location and AS with failed tests to these proxies: THRESHOLD_AVAILABILITY_MIN_DIVERSE_AGENT_POP_FAILURE, minimum number of diverse agents, THRESHOLD_AVAILABILITY_MAX_DIVERSE_AGENT_POP_FAILURE, maximum number of diverse agents (this threshold may be considered met regardless of percentage of agents with failed tests if the total number is greater than this threshold), and/or THRESHOLD_AVAILABILITY_PERC_DIVERSE_AGENT_POP_FAILURE, percentage of diverse agents. The final target thresholds may include: THRESHOLD_AVAILABILITY_MIN_PROXY_TARGETS_FAILED, minimum number of failed targets reached by this proxy, THRESHOLD_AVAILABILITY_MAX_PROXY_TARGETS_FAILED, maximum number of failed targets reached by this proxy, and/or THRESHOLD_AVAILABILITY_PERC_PROXY_TARGETS_FAILED, percentage of failed targets reached by this proxy.

Proxy connect thresholds (while agent count/diversity is met) may include: THRESHOLD_AVAILABILITY_MIN_PROXY_CONNECT_ATTEMPTS_FAILED, minimum number of failed proxy connection attempts, THRESHOLD_AVAILABILITY_MAX_PROXY_CONNECT_ATTEMPTS_FAILED, maximum number of failed proxy connection attempts, and/or THRESHOLD_AVAILABILITY_PERC_PROXY_CONNECT_ATTEMPTS_FAILED, percentage of failed proxy connection attempts. Network connections to proxy (while agent count/diversity is met) may include: THRESHOLD_AVAILABILITY_MIN_PROXY_NETWORK_TESTS_FAILED, minimum number of failed network tests and name resolutions while using proxy, THRESHOLD_AVAILABILITY_MAX_PROXY_NETWORK_TESTS_FAILED, maximum number of failed network tests and name resolutions while using proxy, and/or THRESHOLD_AVAILABILITY_PERC_PROXY_NETWORK_TESTS_FAILED, percentage of failed network tests and name resolutions while using proxy.

If there are a number of failed tests with a common terminal PoP, they may be grouped together under a single Network (PoP) event, with the event key constructed from the PoP node's details (e.g., ASN and location). The detection criteria for terminal PoPs may include having at least THRESHOLD_NETWORK_POP_SIGNAL_SUSPECTED_MIN fail signals and either a significant fail signal percentage (THRESHOLD_NETWORK_POP_SIGNAL_SUSPECTED_PERC) or more than a maximum of THRESHOLD_NETWORK_POP_SIGNAL_SUSPECTED_MAX failed signals involving the terminal PoP node.

A network event signifies a number of network-related issues between a (source AS, source location country) and a (destination AS, destination location country). Similar to Network (PoP), if at least THRESHOLD_NETWORK_SIGNAL_SUSPECTED_MIN failed signals and either the percentage of network-related fail signals that occur between any pair of source (AS and location) and destination (AS, location)s, exceeds a high percentage, THRESHOLD_HNETWORK_SIGNAL_SUSPECTED_PERC, or there is more than a maximum of THRESHOLD_NETWORK_SIGNAL_SUSPECTED_MAX failed signals, those failed signals may be grouped into a Network event that happened between the source and destination (AS, location) pair.

Examples of various thresholds and parameters are included in Table 1.

TABLE 1

| | | |
|---|---|---|
| Parameter | Definition | Values |

Delay and Baselining Thresholds

| | | |
|---|---|---|
| THRESHOLD_E2E_LOSS | The percentage of packets | 10 |
| | lost past which we consider | |
| | it an event. | |
| BASELINE_HTTP_TIMING_HOURS_MEAN | Length of the rolling | 24 |
| BASELINE_PING_TIMING_HOURS_MEAN | window for calculating | |
| | baseline mean. | |
| BASELINE_HTTP_TIMING_HOURS_STD | Length of the rolling | 3 |
| BASELINE_PING_TIMING_HOURS_STD | window for calculating | |
| | baseline standard deviation. | |
| BASELINE_HTTP_TIMING_MIN_LENGTH | Minimum number of | 10 |
| BASELINE_PING_TIMING_MIN_LENGTH | signals for baselining. | |
| BASELINE_HTTP_TIMING_STD_FACTOR | Number of standard | 1 |
| BASELINE_PING_TIMING_STD_FACTOR | deviations we should be | |
| | above the mean to trigger | |
| | an anomaly. | |
| BASELINE_HTTP_TIMING_MIN_DIFF | Minimum amount by | 1000 |
| | which an HTTP test's total | |
| | time + redirect time needs | |
| | to spike above baseline to | |
| | consider it an event. | |
| BASELINE_PING_TIMING_MIN_DIFF | Minimum amount by | 150 |
| | which a network test's | |
| | RTT needs to spike above | |
| | baseline to consider it an | |
| | event. | |
| BASELINE_HTTP_TIMING_CLOSE_CALL_{—} | The factor of | 300 |
| MARG IN | BASELINE_MIN_DIFF_{—} | |
| | PING by which the HTTP | |
| | test could spike before | |
| | hitting the time limit. Used | |
| | to determine close timeouts. | |

General Event Thresholds

| | | |
|---|---|---|
| THRESHOLD_MIN_TOTAL_SIGNALS | The minimum number of | 10 |
| | signals involved to surface | |
| | an event. | |
| THRESHOLD_MIN_SUSPECTED_SIGNALS | The minimum number of | 10 |
| | suspected signals required | |
| | to surface an event. | |

Agent Local Event Thresholds

| | | |
|---|---|---|
| THRESHOLD_LOCAL_EVENT_FAILED_{—} | The thresholds for the | 50 |
| ROOT_DO MAIN_PERC | percentage and minimum | 2 |
| THRESHOLD_LOCAL_EVENT_FAILED_{—} | number of total root | 50 |
| ROOT_DO MAIN_MIN for enterprise agents; and | domains with DNS issues | 4 |
| THRESHOLD_CA_LOCAL_EVENT_FAILED_{—} | for an agent to be | |
| ROOT_DOMAIN_PERC and | considered faulty for one | |
| THRESHOLD_CA_LOCAL_EVENT_FAILED_{—} | bucket. | |
| ROOT_DOMAIN_MIN for cloud agents. | | |
| THRESHOLD_LOCAL_EVENT_FAILED_ASN_{—} | The thresholds for the | 80 |
| PER C_and | percentage and minimum | 2 |
| THRESHOLD_LOCAL_EVENT_FAILED_ASN_{—} | number of total target ASes | 80 |
| MIN for enterprise agents; and | that have failed tests for an | 4 |
| THRESHOLD_CA_LOCAL_EVENT_FAILED_{—} | agent to be considered | |
| ASN_PERC | faulty for one bucket. | |
| THRESHOLD_CA_LOCAL_EVENT_FAILED_{—} | | |
| ASN_MIN for cloud agents. | | |

Target Event Thresholds

| | | |
|---|---|---|
| THRESHOLD_AVAILABILITY_MIN_AGENT_{—} | Minimum/maximum/percentage | 2 |
| FAILURE | of agents with failed | 10 |
| THRESHOLD_AVAILABILITY_MAX_AGENT_{—} | tests to a target for that | 20 |
| FAILURE | target to be considered | |
| THRESHOLD_AVAILABILITY_PERC_AGENT_{—} | unavailable for one bucket. | |
| FAILURE | The number of agents must | |
| | be equal to or larger than | |
| | the minimum and their | |
| | percentage higher than | |
| | threshold, but we consider | |
| | this threshold met if the | |
| | number is above maximum, | |
| | regardless of percentage. | |
| THRESHOLD_AVAILABILITY_MIN_DIVERSE_{—} | Minimum/maximum/percentage | 2 |
| A GENT_POP_FAILURE | number of location- | 5 |
| THRESHOLD_AVAILABILITY_MAX_DIVERSE_{—} | diverse agents based on | 20 |
| A GENT_POP_FAILURE | their location and AS with | |
| THRESHOLD_AVAILABILITY_PERC_DIVERSE_{—} | failed tests to this target. | |
| AGENT_POP_FAILURE | | |

Proxy Event Thresholds

| | | |
|---|---|---|
| THRESHOLD_AVAILABILITY_MIN_AGENT_{—} | Minimum/maximum/percentage | 2 |
| FAILURE | of agents with failed | 10 |
| THRESHOLD_AVAILABILITY_MAX_AGENT_{—} | tests to a target required to | 20 |
| FAILURE | surface a proxy event. | |
| THRESHOLD_AVAILABILITY_PERC_AGENT_{—} | | |
| FAILURE | | |
| THRESHOLD_AVAILABILITY_MIN_PROXY_{—} | Minimum/maximum/percentage | 2 |
| TARGETS_FAILED | of targets with failed | 10 |
| THRESHOLD_AVAILABILITY_MAX_PROXY_{—} | tests required to surface a | 20 |
| TARGETS_FAILED | proxy event. | |
| THRESHOLD_AVAILABILITY_PERC_PROXY_{—} | | |
| TARGETS_FAILED | | |
| THRESHOLD_AVAILABILITY_MIN_PROXY_{—} | Minimum/maximum/percentage | 2 |
| NET WORK_TESTS_FAILED | of failed proxy | 10 |
| THRESHOLD_AVAILABILITY_MAX_PROXY_{—} | network tests required to | 20 |
| NET WORK_TESTS_FAILED | surface a proxy event | |
| THRESHOLD_AVAILABILITY_PERC_PROXY_{—} | | |
| NE TWORK_TESTS_FAILED | | |
| THRESHOLD_AVAILABILITY_MIN_PROXY_{—} | Minimum/maximum/percentage | 4 |
| CON NECT_ATTEMPTS_FAILED | of agents with failed | 50 |
| THRESHOLD_AVAILABILITY_MAX_PROXY_{—} | proxy connection attempts | 20 |
| CON NECT_ATTEMPTS_FAILED | to surface a proxy event. | |
| THRESHOLD_AVAILABILITY_PERC_PROXY_{—} | | |
| CO NNECT_ATTEMPTS_FAILED | | |

Network Event Thresholds

| | | |
|---|---|---|
| THRESHOLD_NETWORK_SIGNAL_{—} | Minimum/maximum/percentage | 5 |
| SUSPECTED_MIN | of suspected signals | 100 |
| THRESHOLD_NETWORK_SIGNAL_{—} | required for surfacing | 5 |
| SUSPECTED_MAX | network events. A less | |
| THRESHOLD_NETWORK_SIGNAL_{—} | strict threshold may be | |
| SUSPECTED_PERC | utilized for suspected | |
| | signals of network events | |
| | due to their key being more | |
| | specific. | |

Network (PoP) Event Thresholds

| | | |
|---|---|---|
| THRESHOLD_NETWORK_POP_SIGNAL_{—} | Minimum/maximum/percentage | 4 |
| SUSPECT ED_MIN | of suspected signals | 10 |
| THRESHOLD_NETWORK_POP_SIGNAL_{—} | required for surfacing | 10 |
| SUSPECT ED_MAX | network pop events. | |
| THRESHOLD_NETWORK_POP_SIGNAL_{—} | | |
| SUSPECT ED_PERC | | |

If a test fails frequently over short periods of time for a long time, its results may be temporarily ignored to avoid introducing noise to the event detection process. This may be done by increasing a penalty value every time a test failure occurs, and then “decaying” it over time when the test is not in error state. If the penalty value goes above the threshold, the test may get “suppressed”, i.e., its outcome may not be considered until the penalty value has again decayed back within the normal range.

Events happening during a bucket round could be merged with events from other buckets if (a) the type and key of the event matches between buckets, and/or (b) the events are not too far apart in time (e.g., there are no two events in the group that are more than 5 minutes apart). At the end of each bucket round, a list (roundEvents) may be created for the events detected during that bucket. Another list (activeEvents) may be created for keeping track of events that could still be merged with new detected events. Events may be exported from activeEvents once they are outside of a merging window (EVENT_MERGE_BUCKET_ROUND_GAP_TOLERANCE) in comparison to the current bucket round and then proceed to processing the next buckets' events.

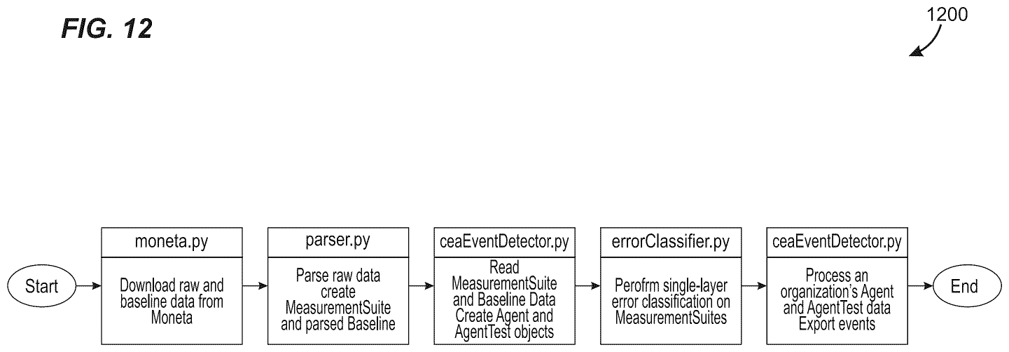

FIG. 12 illustrates an example of a call diagram 1200 for a CEA event detector utility (e.g., a portion of event analysis process 248) for event detection and problem domain identification using user-configured network measurements, in accordance with one or more implementations described herein. A CEA event detector utility may be separated into three main components. The first component may handle obtaining data from a main data source (e.g., moneta) and outputting it in a format that is usable by the rest of the utility components. The second component (e.g., parser) may handle raw data to parse and enrich it into Python data structures that can later be retrieved by the main analysis section. The third and final component (e.g., detector) may handle the actual processing of data, making event detection decisions based on the input data from previous sections. Flowchart 1200 may depict the overall flowchart of how the different components work together.

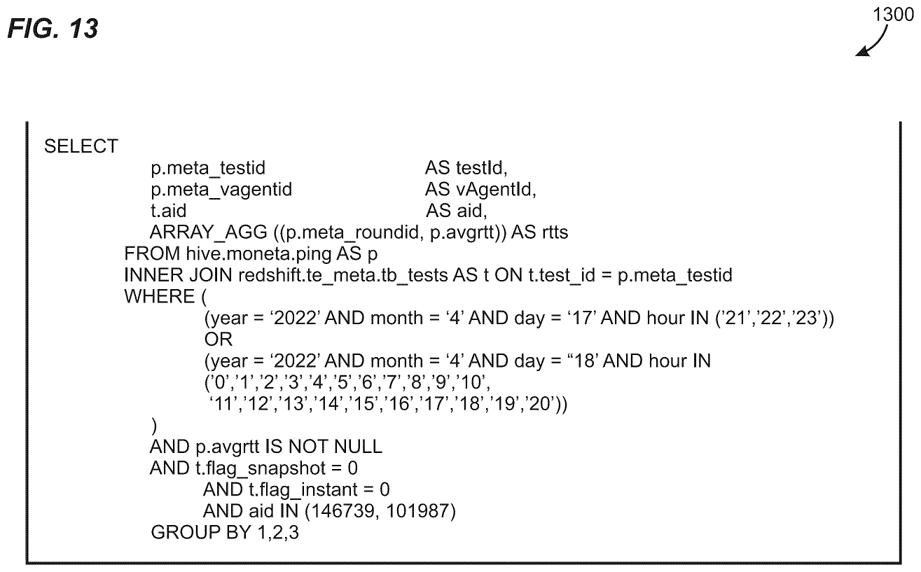

FIG. 13 illustrates an example of a query 1300 for fetching ping baseline data for event detection and problem domain identification using user-configured network measurements, in accordance with one or more implementations described herein. On a high-level, for a given start datetime (e.g., specified by year, month, day, hour, etc.), number of hours, and orgId(s), a moneta.py script may fetch raw data from Moneta tables (e.g., http, ping, path trace, etc.) and create csv files for every hour with all test data during that time frame.

Additionally, moneta.py may fetch baseline ping and HTTP data which is used to compare with an agent's roundtrip, http redirect and total times. moneta.py may first create three directories in the given outputDir, which may be called test, raw, and baselines, respectively. Raw may contain the raw table data from the http, ping, and path trace Moneta tables. Each file in this directory stores data from all roundIds within the specified range. Test may contain the raw table data from the http, ping, and path trace Moneta tables, split into 1-minute buckets. Each file in this directory may store data from a specific roundId incremented by 1 minute. Baselines may contain two files for http, ping. The ping file may contain the average round trip times. The http file may contain the average total and redirect times along with HTTP phase timings (e.g., connect time, SSL time, WAIT time, etc.). These values may be for all the agents within the input orgId(s) for each round during a twenty-four-hour window before the input roundId and stores them for each (testId, vagentId) pair. Other than fetching the raw data, this script also may create a dictionary of aIds (Account Ids) to orgIds. Finally, to detect Cloud Agent local issues, the number of packets sent and received within aid=218 may be queried which contains agent to agent data for all cloud agents.

Given a start datetime and orgId all the (meta_roundid, avgrtt) values may be queried for all vAgents within that organization during a 24-hour window starting before the input roundId. Query 1300 may be an example query when running moneta.py with one orgID and roundID=1650317500 (Apr. 18, 2022, 9:31 PM UTC). In this query, hours prior to 9 PM UTC on April 18, and hours after 9 PM UTC on April 17 are selected to form a 24-hour window for calculating a baseline round trip time for vAgents. The results of the query may be stored in the baseline folder under the moneta_baseline_ping_roundIdStart_24.csv filename. Fetching httpBaseline may be similar to the above.

Given a start datetime and orgId, this method may query the http, ping and path trace tables from Moneta for all the vAgentIds and agentIds within the orgId that have test data within the specified datetime range and create a CSV file containing all the relevant data to the event detection. These CSV files may then be stored in the raw directory (moneta_[test type]_all_[start datetime-hour]. csv).

Once the raw files are downloaded, the split method may essentially split all of the data into buckets based on their roundId values. The output CSV files may be created in the test directory (moneta_[test type] all_[roundId].csv). These files are later used by parser.py. In the event that a specific test type (ex: http) does not have data in a roundId, an empty csv file should be created for the nonexistent roundId.

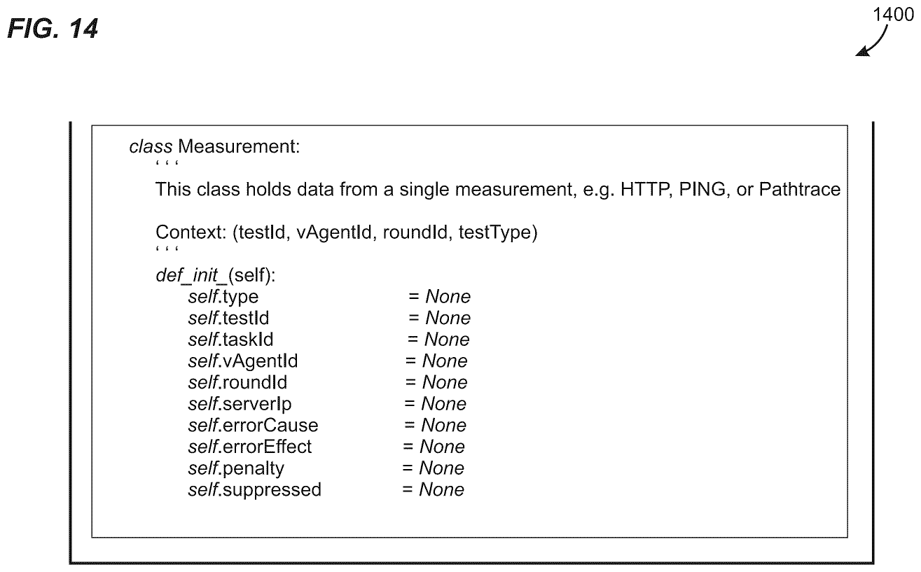

FIG. 14 illustrates an example of a measurement class 1400 for event detection and problem domain identification using user-configured network measurements, in accordance with one or more implementations described herein. On a high-level, the parser may read the raw data fetched by moneta, enrich them, create measurement objects, and/or stores the measurement objects as pickled objects. The measurement object may store the roundId, vAgentId, testId and the cause and effect of the issue along with information. FIG. 14 shows examples of the fields of the measurement class 1400.

With respect to creating measurements, the first step of the parser may be enriching the data. This may include the following steps: reading the CSV files; proceeding to enrich the data by adding information such as AS, geolocation, and/or vagent info; creating measurement objects for each of the data types (e.g., Ping, HTTP, Terminal); and/or stores them as pickle files to be later used (e.g., by ceaEventDetector.py).

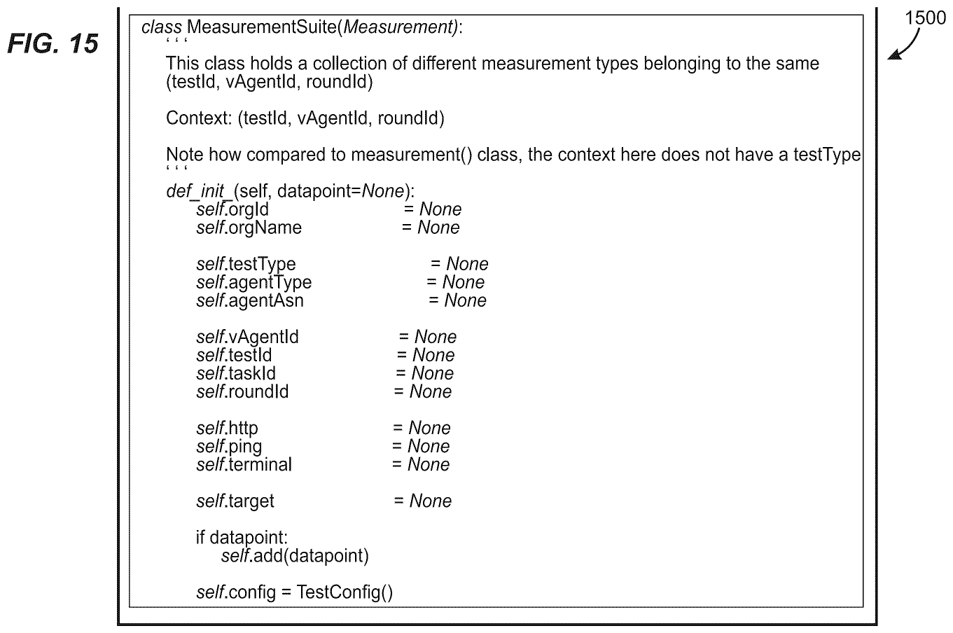

FIG. 15 illustrates an example of a MeasurementSuite class 1500 for event detection and problem domain identification using user-configured network measurements, in accordance with one or more implementations described herein. With respect to creating MeasurementSuites, this object may combine all measurement types (e.g., http, ping and path trace) for a (testId, vAgentId, roundId) pair. It may facilitate the addition of context to failures within a layer. For example, if the error classification of the HTTP data requires additional information, then it may be correlated with network data from the ping data. FIG. 15 depicts the various fields of the MeasurementSuite class 1500.

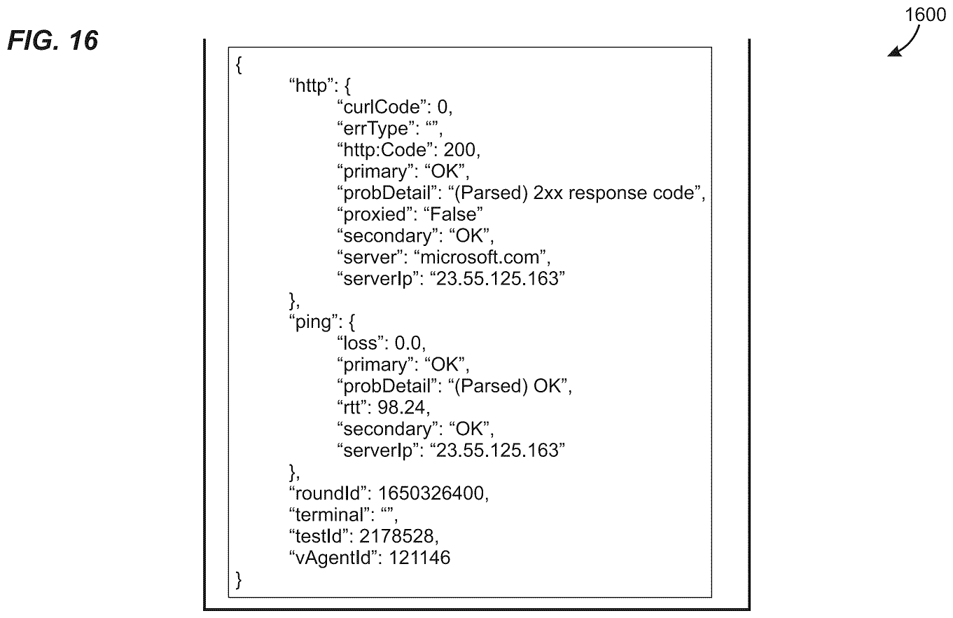

FIG. 16 illustrates an example of a MeasurementSuite object that is stored as a pickle file 1600 for event detection and problem domain identification using user-configured network measurements, in accordance with one or more implementations described herein. After creating MeasurementSuite objects, they may be stored as pickle files (e.g., one file per each org_Id, roundId). From this point only the MeasurementSuite data may be used to detect events. FIG. 16 depicts an example entry in the pickle file 1600 of the MeasurementSuite class. These MeasurementSuites may be analyzed per orgId since it may be necessary to decide the root cause based on organizations.

With respect to creating a baseline, the parseBaseline method may read all the raw baseline files for each orgId and create baseline objects for them and store them as pickle files. The baseline object may contain methods to compute and update the mean and std values for the rtts. Table 2 represents an example row of the raw baseline data for which a baseline is created and for which a mean of the rtt values is created.

TABLE 2

| testId | vAgentId | rtts |
|---|---|---|
| 1285348 | 777931 | [[1650319800, |
| | | 234.22000122070312], |
| | | [1650315600, |
| | | 233.87997436523438], |
| | | . . . |

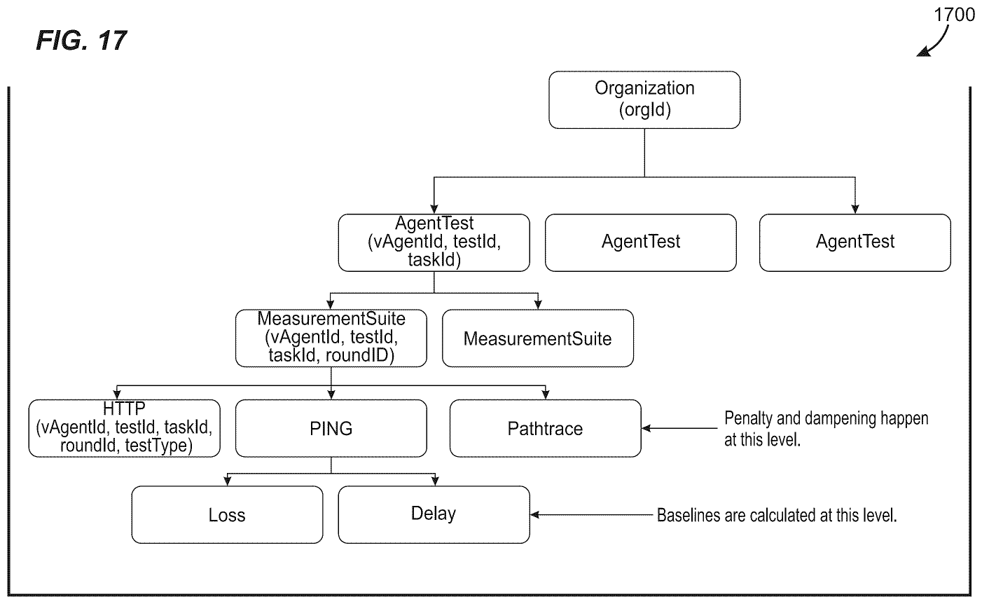

FIG. 17 illustrates an example of a test data hierarchy 1700 for event detection and problem domain identification using user-configured network measurements, in accordance with one or more implementations described herein. Once the data has been parsed and enriched, event detection may begin. As previously stated, events may be detected for each organization. Thus, the data may be bucketized into buckets of five minutes and/or the MeasurementsSuite pickled objects may be loaded to perform single-layer error classification based on their different measurement data (i.e., HTTP and PING) and/or their baselines. The error classification may be performed utilizing ErrorClassifierPing and ErrorClassifierHttp as described in further detail below. Then MeasurementsSuites may be leveraged to create Agent and AgentTest objects. FIG. 17 presents a high-level hierarchy of the test data.

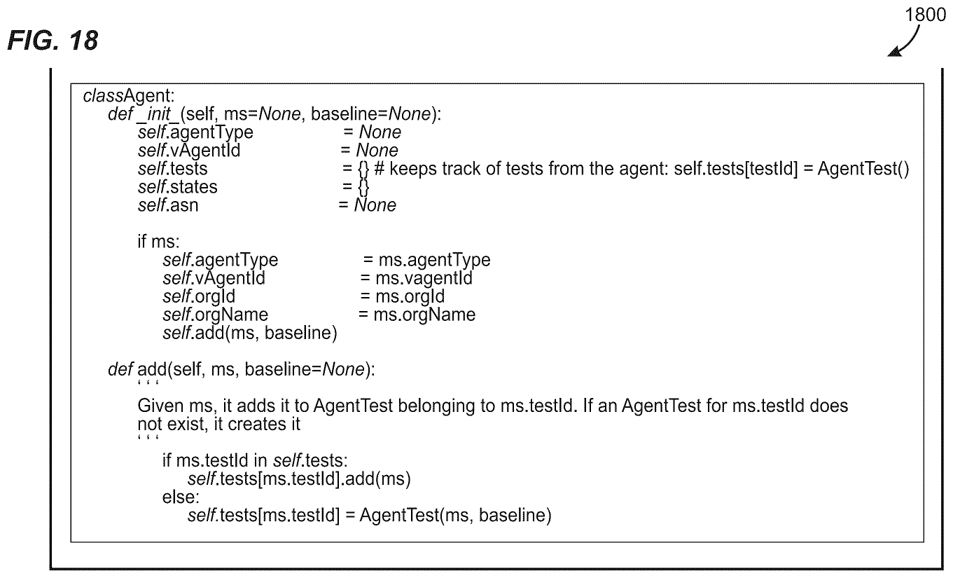

FIG. 18 illustrates and example of an agent class 1800 for event detection and problem domain identification using user-configured network measurements, in accordance with one or more implementations described herein. An agent object may keep track of all the tests performed by this agent using AgentTest objects.

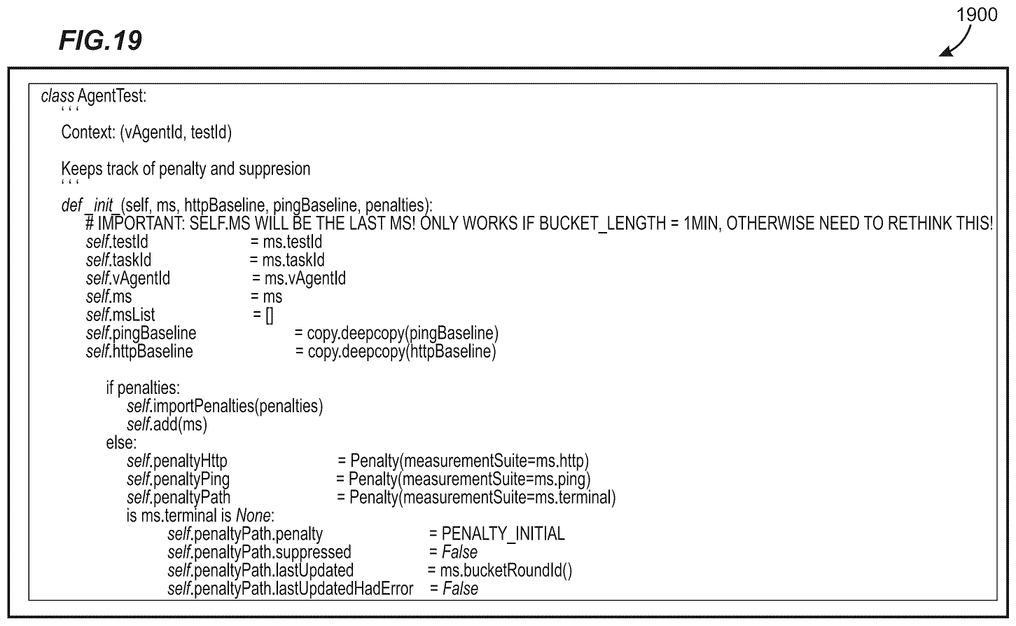

FIG. 19 illustrates an example of an AgentTest class 1900 for event detection and problem domain identification using user-configured network measurements, in accordance with one or more implementations described herein. AgentTest may allow keeping track of the penalty for each test and suppressing them if they pass the defined thresholds.

The next step may be processing the signals based on AgentTests in a given bucket. Once this is done for all agents, all the signals within that bucket may be aggregated in a pool. Then they may be grouped into Events, as outlined in greater detail above.

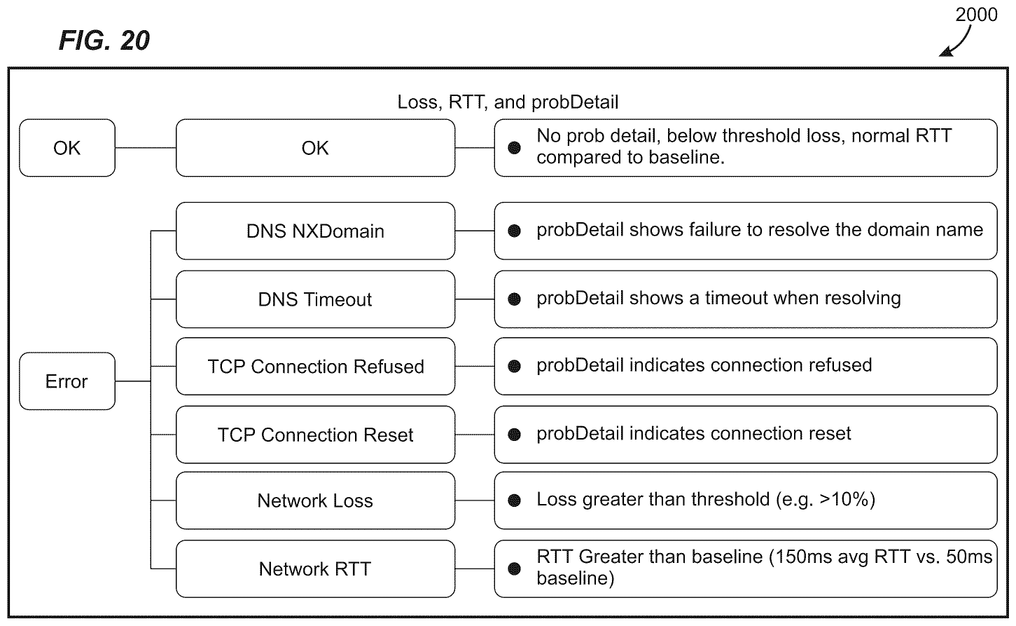

FIG. 20 illustrates an example of an error classification tree 2000 for ping data in event detection and problem domain identification using user-configured network measurements, in accordance with one or more implementations described herein. The error classifier may process and/or label test outcomes based on the results and test metadata (e.g., test time limit). For example, an ErrorClassifierPing method may classify the type of error by looking up a map, mainly based on probDetail (e.g., a human readable string about the cause of the error) and loss rate. The mapping may be derived by domain experts and reading documentations of how different errors occur. FIG. 20 depicts the decision tree used for classifying the error types based on different probDetails and loss. For instance if the probDetail contains “Unable to resolve.* to an IP address” then both the primary and secondary error type may be classified as DNS.

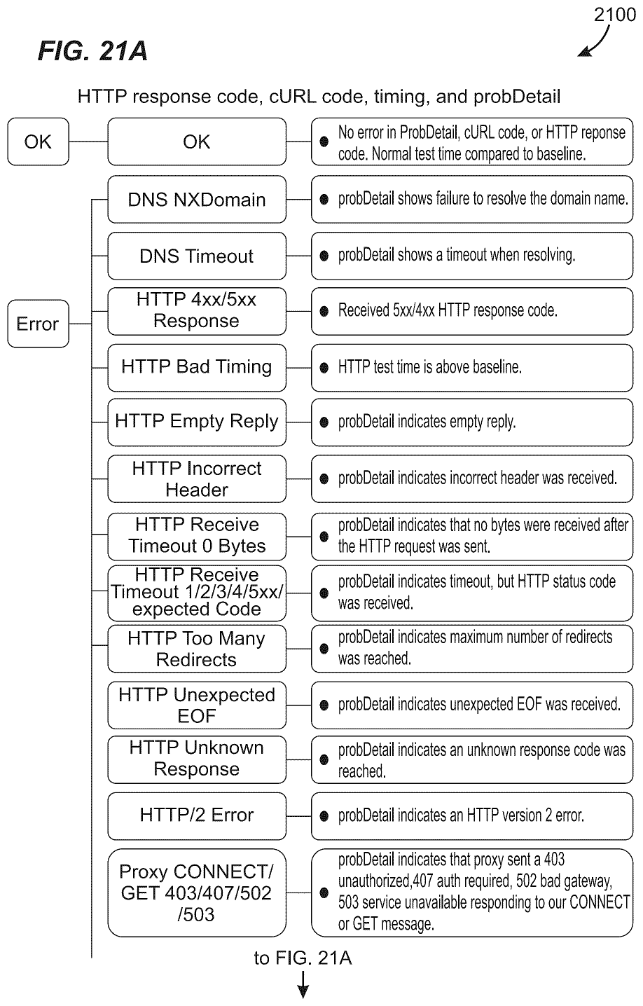

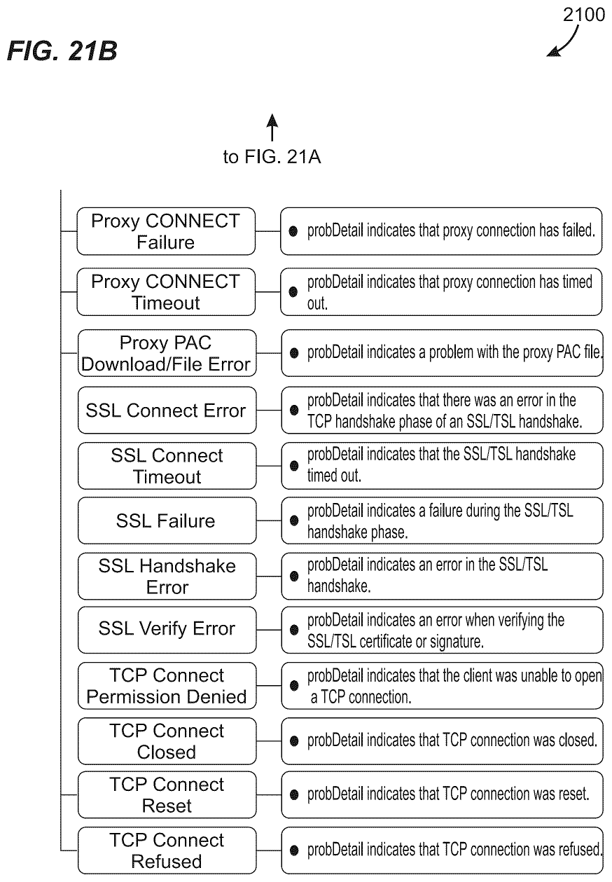

FIGS. 21A-21B illustrate an example of an error classification tree 2100 for HTTP data in event detection and problem domain identification using user-configured network measurements, in accordance with one or more implementations described herein. The ErrorClassifierHTTP method may classify the type of error by looking up a map, given the (curlCode, httpCode, probDetail) tuple. Similar to above, the mapping may be derived by domain experts and reading documentations of how different errors occur. In some instances, the system may use error classification tree 2100 as a decision tree for classifying the error types based on different (curlCode, httpCode, probDetail) tuples.

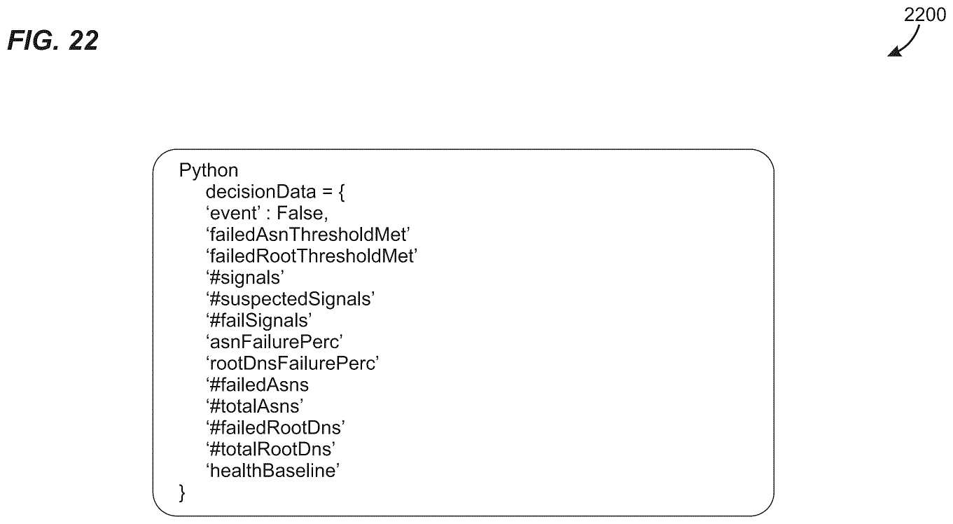

FIG. 22 illustrates an example of event decision data 2200 for event detection and problem domain identification using user-configured network measurements, in accordance with one or more implementations described herein. For each component, a dictionary called “decisionData” may be exported, which includes the various thresholds that were/weren't met for that component. In other words, it includes the criteria that was checked for a component, in order to decide if it is having issues or not. For example, event decision data 2200 includes examples of some of the fields that may be exported in decisionData for an agent component.

CEA event detection may be performed across various steps including fetching data, parsing and enriching fetched data (e.g., mapping Ips to prefixes and ASNs), and/or detecting events (which may include processing and classifying signals and/or aggregating signals around faulty components as “events.” In some instances, the detection may be limited to HTTP, ping, and path trace data. However, in some instance, other layers such as page load and BGP are added. As previously mentioned, CEA event detection may be per organization. ceaEventDetector.py may include ceaEventDetector.process( ) and/or ceaEventDetector.loadMsFileByAgent( ).

In various implementations, a warm-up period may be utilized. That is, to allow penalty and suppression states to stabilize, a warm-up period may be implemented. During this period, penalties may be applied, and suppression states may be updated, but no events may be detected.

For a network event based on terminal interfaces, grouping may be done by (asn, geonameId). However, sometimes a valid terminal interface, i.e., not suppressed and correlating with e2e loss, might be missing asn (e.g., IP is not advertised in BGP or it's private) or geonameId (i.e., the geolocation algorithm failed to geolocate the node 2). In the absence of asn and/or geonameId, that terminal interface may be ignored in detecting events. However, this approach may be too restrictive, resulting in ignoring many, otherwise valid, terminal interfaces. To remedy this, if a node is missing asn, the last seen asn in the path trace may be used. If a node is missing geonameId, the last seen geonameId in the path trace may be used, if the delay between the two nodes is smaller than a threshold.

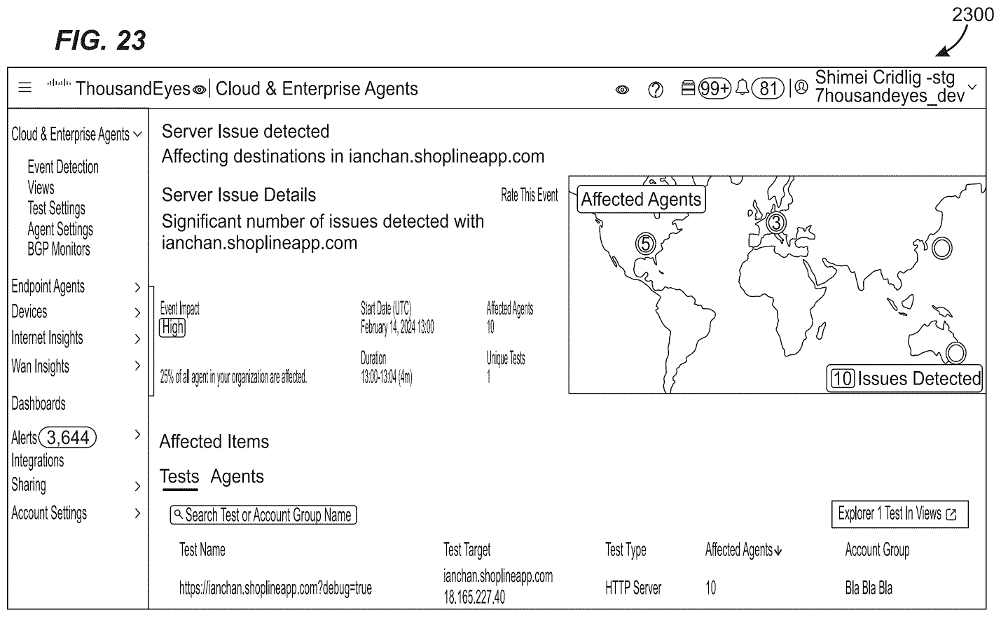

FIG. 23 illustrates an example of an interface 2300 of a utility for event detection and problem domain identification using user-configured network measurements, in accordance with one or more implementations described herein. This interface 2300 shows an event that is causing tests that are targeting a specific application server to fail. The problem domain was correctly identified and presented as the server, along with a list of all affected signals and agents as well as other useful information about the event are presented to the user.

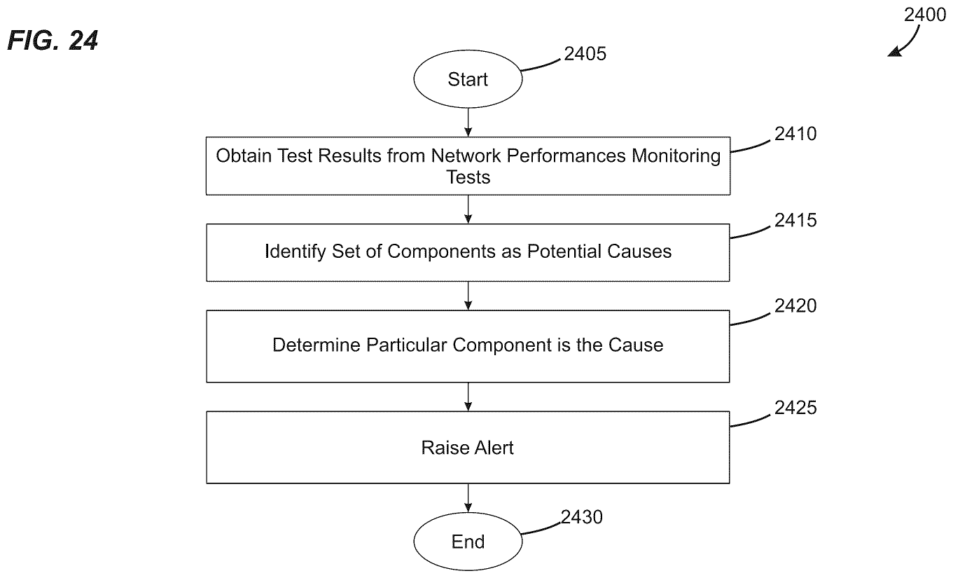

FIG. 24 illustrates an example procedure 2400 (e.g., a method) for event detection and problem domain identification using user-configured network measurements, in accordance with one or more embodiments described herein. For example, a non-generic, specifically configured device (e.g., device 200), such as a router, firewall, controller for a network (e.g., an SDN controller or other device in communication therewith), server, or the like, or a combination thereof, may perform procedure 2400 by executing stored instructions (e.g., event analysis process 248). The procedure 2400 may start at step 2405, and continues to step 2410, where, as described in greater detail above, the device may obtain test results from a plurality of performance monitoring tests performed in a computer network. In some instances, the test results indicate that the plurality of performance monitoring tests failed. In various implementations, the plurality of performance monitoring tests comprises one or more of: a page load test, a Hypertext Transfer Protocol (HTTP) test, a ping test, or a path trace test. In some implementations, agents distributed in the computer network perform the plurality of performance monitoring tests.

At step 2415, as detailed above, the device may identify a set of components of the computer network as potential causes of the test results. In some implementations, this may entail applying a classifier to the test results that outputs the set of components of the computer network the potential causes of the test results, whereby different components in the set of components are associated with different layers of the computer network. In a further implementation, this may entail filtering out test results for performance monitoring tests based on a number or rate of failed tests in a given period of time.

At step 2420, the device may determine that a particular component from among the set of components caused the test results based on its health metrics, as described in greater detail above. In various implementations, the device may do so by determining that health metrics for the particular component deviated from a baseline model during performance of the plurality of performance monitoring tests. In some instances, the particular component is one of: an agent, a server, a target network, a proxy, a network terminal hop, or a network path in the computer network.

At step 2425, as detailed above, the device may raise an alert indicative of the particular component having caused the test results. In various implementations, the device was not configured by a user to provide alerts of a type associated with the alert. Indeed, the techniques herein are able to generate alerts. In some cases, the device provides the alert to a user interface for presentation to a user.

Procedure 2400 then ends at step 2430.

It should be noted that while certain steps within procedure 2400 may be optional as described above, the steps shown in FIG. 24 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

It should be noted that while certain steps or components described herein may be optional as described above, the steps and components shown are merely examples for illustration, and certain other steps may be included or excluded as desired. Further, while a particular order or arrangement of the steps and component is shown, this ordering is merely illustrative, and any suitable arrangement of the steps may be utilized without departing from the scope of the implementations herein.

The techniques described herein, therefore, provide a significant advancement in automated network monitoring by significantly reducing the time and expertise required to identify and resolve network issues. By leveraging user configured tests and establishing dynamic baselines for key performance metrics, the system can flag anomalies in real time with high accuracy. Further, the application of a penalty-based filtering method effectively suppresses noisy signals, ensuring only relevant data is analyzed. Furthermore, the introduced approach of grouping signals around involved components and comparing them to health baselines facilitates precise event detection and categorization, facilitating rapid root cause analysis. This approach not only enhances the efficiency and reliability of network monitoring but also minimizes operational disruptions and reduces the dependency on specialized network expertise. Consequently, these techniques transform observability platforms from mere data collection tools into comprehensive solutions for end-to-end network anomaly detection and management, addressing a critical absence in the current network monitoring landscape.

While there have been shown and described illustrative implementations that provide for event detection and problem domain identification using user-configured network measurements, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
obtaining, by a device, test results from a plurality of performance monitoring tests performed in a computer network;
identifying, by the device, a set of components of the computer network as potential causes of the test results;
determining, by the device, that a particular component from among the set of components caused the test results based on its health metrics; and
raising, by the device, an alert indicative of the particular component having caused the test results.

2. The method as in claim 1, wherein the test results indicate that the plurality of performance monitoring tests failed.

3. The method as in claim 1, wherein the plurality of performance monitoring tests comprises one or more of: a page load test, a Hypertext Transfer Protocol (HTTP) test, a ping test, or a path trace test.

4. The method as in claim 1, wherein agents distributed in the computer network perform the plurality of performance monitoring tests.

5. The method as in claim 1, wherein determining that a particular component from among the set of components caused the test results based on its health metrics comprises:
determining that health metrics for the particular component deviated from a baseline model during performance of the plurality of performance monitoring tests.

6. The method as in claim 1, wherein identifying the set of components of the computer network as potential causes of the test results comprises:
applying a classifier to the test results that outputs the set of components of the computer network the potential causes of the test results, wherein different components in the set of components are associated with different layers of the computer network.

7. The method as in claim 1, wherein identifying the set of components of the computer network as potential causes of the test results comprises:
filtering out test results for performance monitoring tests based on a number or rate of failed tests in a given period of time.

8. The method as in claim 1, wherein the device was not configured by a user to provide alerts of a type associated with the alert.

9. The method as in claim 1, wherein the particular component is one of an agent, a server, a target network, a proxy, a network terminal hop, or a network path in the computer network.

10. The method as in claim 1, wherein the device provides the alert to a user interface for presentation to a user.

11. An apparatus, comprising:
one or more network interfaces;
a processor coupled to the one or more network interfaces and configured to execute one or more processes; and
a memory configured to store a process that is executable by the processor, the process when executed configured to:
obtain test results from a plurality of performance monitoring tests performed in a computer network;
identify a set of components of the computer network as potential causes of the test results;
determine that a particular component from among the set of components caused the test results based on its health metrics; and
raise an alert indicative of the particular component having caused the test results.

12. The apparatus as in claim 11, wherein the test results indicate that the plurality of performance monitoring tests failed.

13. The apparatus as in claim 11, wherein the plurality of performance monitoring tests comprises one or more of: a page load test, a Hypertext Transfer Protocol (HTTP) test, a ping test, or a path trace test.

14. The apparatus as in claim 11, wherein agents distributed in the computer network perform the plurality of performance monitoring tests.

15. The apparatus as in claim 11, wherein the apparatus determines that a particular component from among the set of components caused the test results based on its health metrics by:
determining that health metrics for the particular component deviated from a baseline model during performance of the plurality of performance monitoring tests.

16. The apparatus as in claim 11, wherein the apparatus identifies the set of components of the computer network as potential causes of the test results by:
applying a classifier to the test results that outputs the set of components of the computer network the potential causes of the test results, wherein different components in the set of components are associated with different layers of the computer network.

17. The apparatus as in claim 11, wherein identifying the set of components of the computer network as potential causes of the test results comprises:
filtering out test results for performance monitoring tests based on a number or rate of failed tests in a given period of time.

18. The apparatus as in claim 11, wherein the apparatus was not configured by a user to provide alerts of a type associated with the alert.

19. The apparatus as in claim 11, wherein the particular component is one of an agent, a server, a target network, a proxy, a network terminal hop, or a network path in the computer network.

20. A tangible, non-transitory, computer-readable medium storing program instructions that cause a device to execute a process comprising:
obtaining, by the device, test results from a plurality of performance monitoring tests performed in a computer network;
identifying, by the device, a set of components of the computer network as potential causes of the test results;
determining, by the device, that a particular component from among the set of components caused the test results based on its health metrics; and
raising, by the device, an alert indicative of the particular component having caused the test results.
